(19) United States
(12) Patent Application Publication
(10) Pub. No.: US 2026/0290096 A1
(43) Pub. Date: Sep. 24, 2026

(54) ELECTRONIC LOCKSET WITH GEOFENCE-BASED AUTOMATIC LOCKING AND UNLOCKING

(71) Applicant: ASSA ABLOY Americas Residential Inc., New Haven, CT (US)

(72) Inventors: Harsh Khera, San Diego, CA (US); James Lin, Laguna Niguel, CA (US); Van Ty Tran, Santa Ana, CA (US)

(21) Appl. No.: 19/573,562

(22) Filed: Mar. 20, 2026

Related U.S. Application Data
(60) Provisional application No. 63/774,923, filed on Mar. 20, 2025.

(51) Int. Cl. G07C 9/00; E05B 47/00

(52) U.S. Cl. CPC G07C 9/00309; E05B 47/0012; G07C 2009/00325

(57) ABSTRACT

In general, an electronic lock with geofence-based automatic locking and unlocking is disclosed. In example aspects, a geofence including an exit boundary and an entry boundary may be defined around a location of interest, such as an electronic lockset. The exit boundary may be defined at a first predetermined range around the electronic lockset, and the entry boundary may be defined at a second predetermined range around the electronic lockset. The first predetermined range and the second predetermined range may be based on wireless communication capabilities of the electronic lockset. When the user moves beyond the exit boundary, a lock command may be automatically transmitted to the electronic lockset. Similarly, when the user moves within the entry boundary, an unlock command may be automatically transmitted to the electronic lockset.

### CROSS-REFERENCE TO RELATED APPLICATIONS

This application claims priority to U.S. Provisional Patent Application No. 63/774,923, filed Mar. 20, 2025, the disclosure of which is incorporated herein by reference in its entirety.

### BACKGROUND

Electronic locksets are commonly used to control access to a secure location. For example, users may use electronic locksets to control access to their homes. These users may use credentials, physical keys, or other similar mechanisms to lock and unlock the electronic locksets. However, each time the user wishes to lock and unlock the electronic lockset, the user may need to provide their credentials or keys.

### SUMMARY

In general, an electronic lock with geofence-based automatic locking and unlocking is disclosed. A geofence including an entry boundary and an exit boundary may be defined around a location of interest, such as an electronic lockset. When the user moves within the entry boundary, an unlock command may be automatically transmitted to the electronic lockset. Similarly, when the user moves beyond the exit boundary, a lock command may be automatically transmitted to the electronic lockset.

In a first aspect, a method for controlling operation of an electronic lockset is provided. A geofence is defined that includes an exit boundary. The exit boundary is defined at a predetermined range around an electronic lockset. The predetermined range is based on wireless communication capabilities of the electronic lockset. An occurrence of an exit event is determined. A location of a user is determined. Whether the location of the user is located beyond the exit boundary is determined. If the location of the user is located beyond the exit boundary, a lock command is transmitted to the electronic lockset.

In a second aspect, a system for controlling operation of an electronic lockset is provided. The system includes one or more processors and one or more computer-readable storage devices storing data instructions. Execution of the data instructions by the one or more processors causes the system to define a geofence including an entry boundary defined at a predetermined range around an electronic lockset, determine an occurrence of an entry event, determine a location of the user, determine whether the location of the user is located within the entry boundary, and if the location of the user is located within the entry boundary, transmit an unlock command to the electronic lockset. The predetermined range at which the entry boundary is defined is based on wireless communication capabilities of the electronic lockset.

In a third aspect, an electronic lockset is provided. The electronic lockset comprises at least one processor, one or more wireless communication interfaces defining wireless communication capabilities of the electronic lockset, a bolt moveable between a locked position and an unlocked position, a motor actuatable by the processor to move the bolt between the locked position and the unlocked position, and a memory communicatively connected to the at least one processor and storing instructions. Execution of the instructions causes the electronic lockset to actuate the motor to move the bolt from the unlocked position to the locked position in response to receiving a lock command and actuate the motor to move the bolt from the locked position to the unlocked position in response to receiving an unlock command. The lock command is transmitted from the mobile device in response to a location of a user moving beyond an exit boundary. The exit boundary is defined at a first predetermined range around the electronic lockset. The unlock command is transmitted from the mobile device in response to the location of the user moving within an entry boundary. The entry boundary is defined at a second predetermined range around the electronic lockset. The first predetermined range and the second predetermined range are based on wireless communication capabilities of the electronic lockset.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an environment including an electronic lockset in which aspects of the present disclosure may be implemented.

FIG. 2 illustrates a side view of a portion of an electronic lockset usable within the environment of FIG. 1.

FIG. 3 illustrates a rear perspective view of a portion of an electronic lock usable within the environment of FIG. 1.

FIG. 4 illustrates a front perspective view of a portion of an electronic lock usable within the environment of FIG. 1.

FIG. 5 illustrates a schematic representation of an electronic lock, in accordance with aspects of the present disclosure.

FIG. 6 illustrates a schematic representation of a mobile device seen in the environment of FIG. 1.

FIG. 7 illustrates a geofence.

FIG. 8 illustrates a flowchart of a method for defining a geofence.

FIG. 9 illustrates an example automatic locking operation of an electronic lockset using a geofence.

FIG. 10 illustrates a flowchart of a method for automatically locking an electronic lockset using a geofence.

FIG. 11 illustrates a flowchart of a method for automatically locking an electronic lockset when geofence features are unavailable.

FIG. 12 illustrates an example automatic unlocking operation of an electronic lockset using a geofence.

FIG. 13 illustrates a flowchart of a method for automatically unlocking an electronic lockset using a geofence.

FIG. 14 illustrates a flowchart of a method for automatically unlocking an electronic lockset when geofence features are unavailable.

FIG. 15 illustrates a lock configuration user interface.

FIG. 16 illustrates a geofence configuration user interface.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As briefly described above, embodiments of the present invention relate to an electronic lock with geofence-based automatic locking and unlocking (auto-lock and auto-unlock). In example aspects, the geofence defines one or more boundaries at which auto-lock or auto-unlock operations are performed. For example, when the user is leaving their home or other location secured by the electronic lockset, the electronic lockset may automatically lock when the user moves beyond an exit boundary. Similarly, when the user returns home, the electronic lockset may automatically unlock when the user moves within an entry boundary. By using the geofence auto-lock and auto-unlock features, the user can secure and access their home (or other secure location) without needing to manually provide a key or other credentials to actuate the electronic lockset.

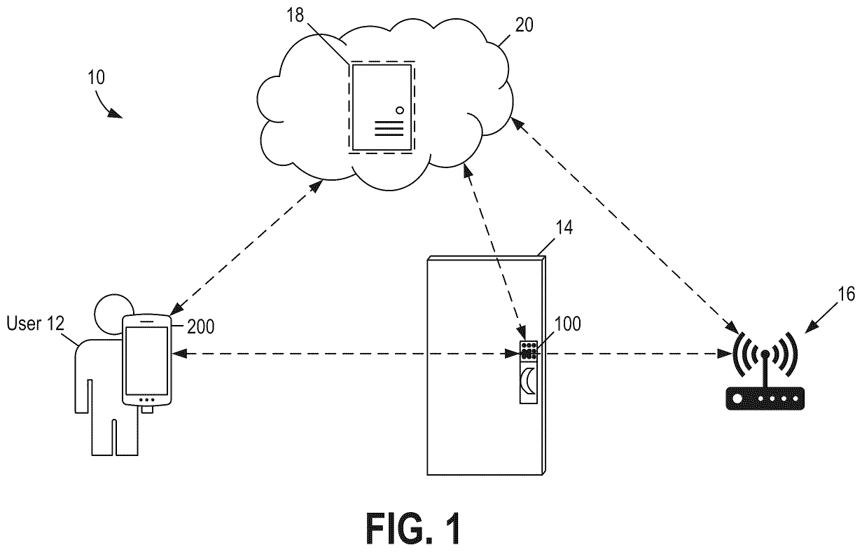

Turning now to FIG. 1, an environment 10 in which aspects of the present disclosure may be implemented is shown. The environment 10 includes a user 12, a mobile device 200, a door 14, a lockset 100, a wireless router 16, and a server 18.

The user 12 may interact with the lockset 100 to, for example, install the lockset 100, actuate a locking mechanism, check a status of the lock, update a lock setting, or perform another operation related to the lock 100. In some instances, the user 12 may be registered with the lockset 100 or may otherwise be authorized to actuate the lockset 100, such as an owner or tenant of the secured area where the door 14 comprising the lockset 100 is installed. In some instances, the user 12 may have a code that he or she may enter at a keypad of the lockset 100 to actuate the locking mechanism, either in addition to or to the exclusion of the user being otherwise registered or authorized at the electronic lock 100 (e.g., via connectivity between the mobile device 200 of the user 12 and the electronic lock 100).

The door 14 may be an interior or exterior door installed at a secured area. Described below are non-limiting examples of a wireless electronic lockset mounted to the door 14. It should be noted that the lockset 100 may be used on other types of doors, such as a garage door, garden shed door, lockbox door, sliding door, doggie door, or other types of doors that require an authentication process to unlock (or lock) the door.

The lockset 100 may be an electronic lockset that is configured to lock and unlock the door 14. In some embodiments, the lockset 100 may be configured to lock or unlock the door 14 in response to receiving credentials associated with an authorized user. For example, the lockset 100 may receive and verify credentials from the mobile device 200. As described further herein, the mobile device 200 may automatically transmit lock and unlock commands in response to movement of the user 12 and the mobile device 200 with respect to a geofence. In some embodiments, the lockset 100 may include wireless communication capabilities. For example, the lockset 100 may include components for communicating with the user 12, the mobile device 200, and the server 18.

The user 12 may be associated with the mobile device 200. For example, the user 12 may carry the mobile device 200 or be the owner of the mobile device 200. The mobile device 200 may be a device with wireless communication capabilities, such as a smartphone, tablet, or key fob. The mobile device 200 may be capable of communicating with the lockset 100, communicating with the server 18, communicating with other mobile devices, and communicating with the router 16. The mobile device 200 may have a mobile application installed thereon that is associated with the lockset 100 or the server 18. The mobile device 200 may include a web browser for accessing a program to communicate with the lockset 100 or the server 18.

The router 16 may be a Wi-Fi router. In some embodiments, the router 16 may be located within the secured area or building to which the door 14 is attached. The router 16 may be capable of communicating with the lockset 100, and the router 16 may be capable of communicating with the server 18. The router 16 may route communications between the server 18 and the lockset 100. In some embodiments, the router may be a hub for Internet of Things (IoT) devices. In some embodiments, the lockset 100 and the router 16 may be coupled via a mesh network. For instance, communication between the lockset 100 and the router 16 may be passed through one or more other devices.

The server 18 can be, for example, a physical server or a virtual server hosted on a cloud platform 20. In examples, the cloud platform 20 may be a multi-cloud platform, a private cloud, a public cloud, or a hybrid cloud. In some embodiments, the server 18 may include a cluster of servers or nodes. In some embodiments, the lockset 100 is also capable of communicating with the server 18. Such communication can optionally occur via one or more wireless communication protocols, e.g., Wi-Fi (IEEE 802.11), short-range wireless communication to a Wi-Fi bridge, or other connection mechanism. According to an embodiment, the server 18 may create and store an account associated with one or more of the lockset 100, the user 12, the mobile device 200, the router 16, the door 14, or a building on which the door 14 is installed. In some embodiments, the server 18 may create or store credentials for one or more of the accounts.

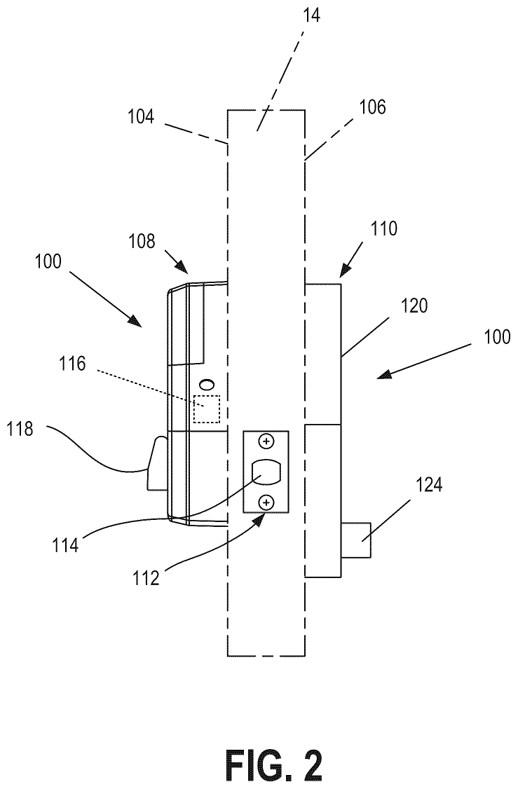

FIG. 2 illustrates a lockset 100 as installed at a door 14, according to one example of the present disclosure. The door 14 has an interior side 104 and an exterior side 106. The lockset 100 includes an interior assembly 108, an exterior assembly 110, and a latch assembly 112. To move the lockset 100 from a locked state to an unlocked state, or from an unlocked state to a locked state, the lockset 100 may actuate the latch assembly 112. The latch assembly 112 is shown to include a bolt 114 that is movable between an extended position (locked) and a retracted position (unlocked, shown in FIGS. 2-4). Specifically, the bolt 114 is configured to slide longitudinally and, when the bolt 114 is retracted, the door 14 is in an unlocked state. When the bolt 114 is extended, the bolt 114 protrudes from the door 14 into a doorjamb to place the door in a locked state. In examples, a processor of the lockset 100 may use a motor to actuate the bolt 114.

In some examples, the interior assembly 108 is mounted to the interior side 104 of the door 14, and the exterior assembly 110 is mounted to the exterior side 106 of the door 14. The latch assembly 112 is typically at least partially mounted in a bore formed in the door 14. The term outside is broadly used to mean an area outside the door 14, and the term inside is broadly used to denote an area inside the door 14. With an exterior entry door, for example, the exterior assembly 110 may be mounted outside a building, while the interior assembly 108 may be mounted inside a building. With an interior door, the exterior assembly 110 may be mounted inside a building, but outside a room secured by the lockset 100, and the interior assembly 108 may be mounted inside the secured room. The lockset 100 is applicable to both interior and exterior doors.

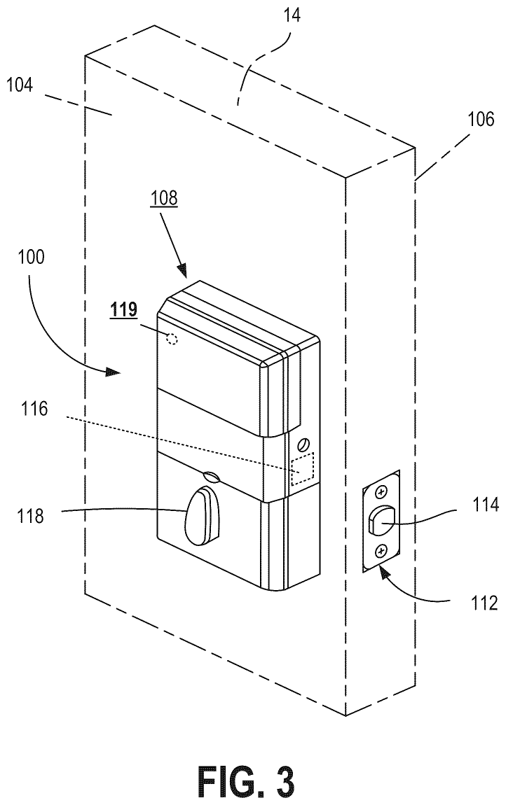

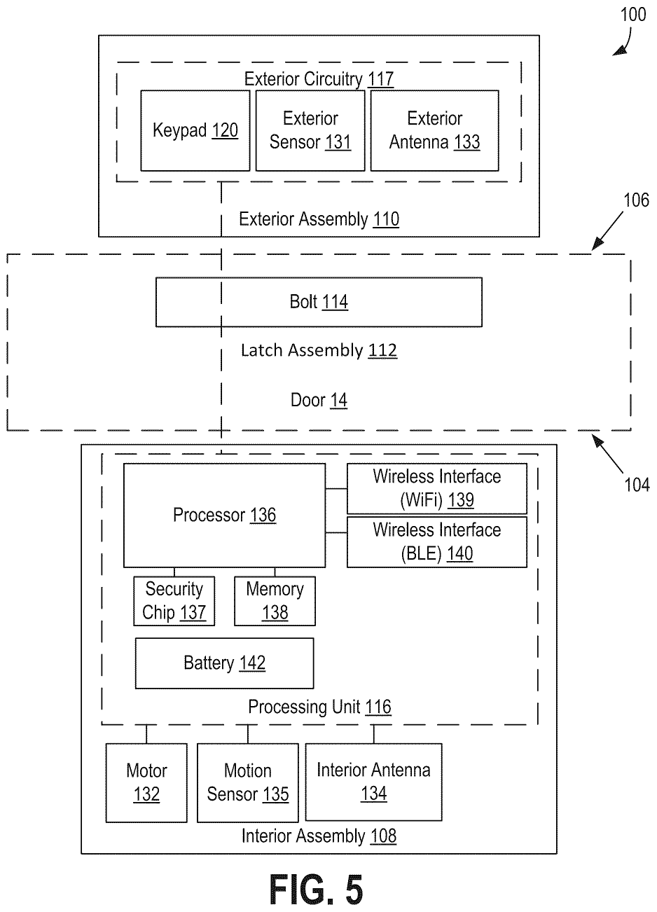

FIG. 3 illustrates a perspective view of the lockset 100 from an interior of the door 14. In some embodiments, the interior assembly 108 can include a processing unit 116 (shown schematically in FIG. 5) containing electronic circuitry for the lockset 100. In some examples, the interior assembly 108 includes a manual turn piece 118 that can be used on the interior side 104 of door 14 to move the bolt 114 between the extended and retracted positions. The processing unit 116 is operable to execute a plurality of software instructions (e.g., firmware) that, when executed by the processing unit 116, cause the lockset 100 to implement the methods and otherwise operate and have functionality as described herein. The processing unit 116 may comprise a device commonly referred to as a processor, e.g., a central processing unit (CPU), digital signal processor (DSP), or other similar device, and may be embodied as a standalone unit or as a device shared with components of the lockset 100. The processing unit 116 may include memory communicatively interfaced to the processor for storing the software instructions. Alternatively, the lockset 100 may further comprise a separate memory device for storing the software instructions that is electrically connected to the processing unit 116 for the bi-directional communication of the instructions, data, and signals therebetween.

In some examples, the interior assembly 108 includes a pairing button 119 (shown schematically), which when actuated, initiates a pairing mode for a connection over an interface. For example, the pairing mode may enable the lockset 100 to communicate with a mobile device (e.g., the mobile device 200) within wireless communication range for enabling the mobile device to be paired with the lockset 100. In some embodiments, once the lockset 100 is paired with the mobile device, the mobile device may be used as part of installing the lockset 100. Similarly, the mobile device may be used to transmit lock and unlock commands to the electronic lockset 100 once paired. In other embodiments, the mobile device 200 need not be paired with the lockset 100 to execute aspects of an installation process for the lockset 100 or transmit commands to the lockset 100. As can be appreciated, initiating the pairing mode via an actuation of the pairing button 119 may be limited to users who have access to the interior side 104 of the door 14. In some embodiments, the lockset 100 may be coupled with a mobile device without use of the pairing button 119. For instance, pairing may be performed by communicating with the server 18, or one or more of the mobile device 200 or the lockset 100 may broadcast a signal for pairing.

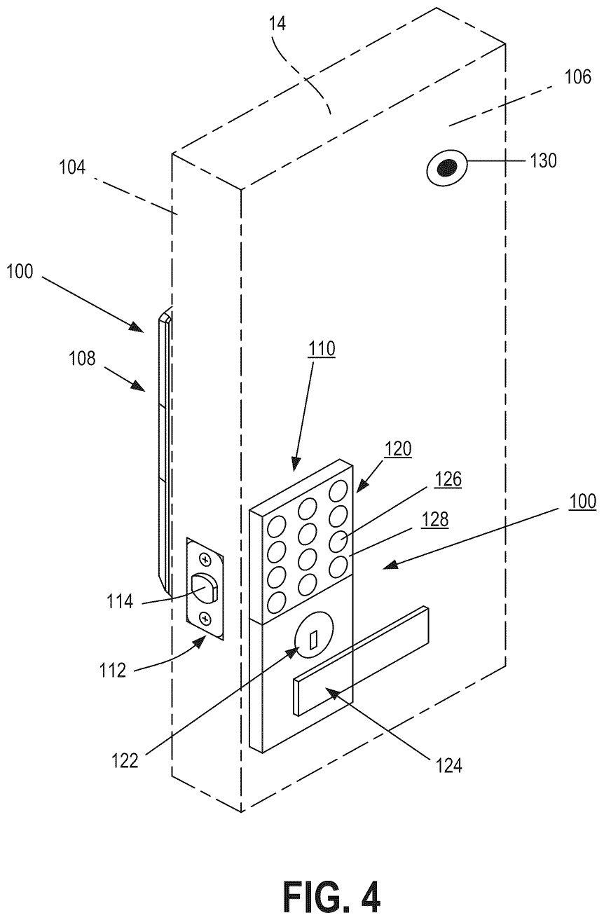

FIG. 4 illustrates a perspective view of the lockset 100 from an exterior of the door 14. The exterior assembly 110 can include exterior circuitry 117 communicatively and electrically connected to the processing unit 116. For example, the exterior assembly 110 can include a keypad 120 for receiving a user input and/or a keyway 122 for receiving a key. The exterior side 106 of the door 14 can also include a handle 124. In some examples, the exterior assembly 110 includes the keypad 120 and not the keyway 122. In some examples, the exterior assembly 110 includes the keyway 122 and not the keypad 120. In some examples, the exterior assembly 110 includes the keyway 122 and the keypad 120. In some examples, the exterior assembly 110 includes neither the keyway 122 nor the keypad 120. When a valid key is inserted into the keyway 122, the valid key can move the bolt 114 between the extended and retracted positions.

When a user inputs a valid actuation passcode into the keypad 120, the bolt 114 may be moved between the extended and retracted positions. In some examples, the exterior assembly 110 is electrically connected to the interior assembly 108. Specifically, in some examples, the keypad 120 may be electrically connected to the interior assembly 108, specifically to the processing unit 116, by, for example, an electrical cable (not shown) that passes through the door 14. When the user inputs a valid actuation passcode via the keypad 120 that is recognized by the processing unit 116, an electrical motor is energized to retract the bolt 114 of latch assembly 112, thus permitting door 14 to be opened from a closed position. In some embodiments, the lockset 100 may be wirelessly actuated without using the keypad 120. For example, the lockset 100 may wirelessly receive an actuation command (e.g., a lock command or an unlock command) from the user 12 or the mobile device 200. The actuation command may be accompanied by credentials that may be authenticated by the lockset 100 prior to locking or unlocking. In some embodiments, the lockset 100 may implement a plurality of authentication techniques. For example, the lockset 100 may require a code to be input at the keypad 120 and may require credentials authorizing a user from the mobile device 200. Still further, an electrical connection between the exterior assembly 110 and the interior assembly 108 allows the processing unit 116 to communicate with other features included in the exterior assembly 110, as noted below.

The keypad 120 can be any of a variety of different types of keypads. The keypad 120 can be one of a numeric keypad, an alpha keypad, and/or an alphanumeric keypad. The keypad 120 can have a plurality of characters displayed thereon. For example, the keypad 120 can include a plurality of buttons 126 that can be mechanically actuated by the user (e.g., physically pressed).

In some examples, the keypad 120 includes a touch interface 128, such as a touch screen or a touch keypad, for receiving a user input. The touch interface 128 is configured to detect a user's “press of a button” by contact without the need for pressure or mechanical actuation. In some embodiments, interacting with the keypad 120 may cause an electrical component of the lockset 100 to be activated (e.g., may cause a switch to close), which may allow the user to actuate the bolt 114 using the keypad 120.

In alternative embodiments, one or more other types of user interface devices can be incorporated into the lockset 100. For example, in example implementations, the exterior assembly 110 can include a biometric interface (e.g., a fingerprint sensor, retina scanner, or camera including facial recognition), or an audio interface by which voice recognition could be used to actuate the lock. Still further, other touch interfaces may be implemented, e.g., where a single touch may be used to actuate the lock rather than requiring entry of a specified actuation passcode.

In some embodiments, the lockset 100 may be coupled to a camera 130. In some embodiments, the camera 130 may be disposed on the exterior side 106 of the door 14. In some embodiments, the camera 130 may be activated by a processing unit of the lockset 100. In some embodiments, the camera 130 may detect movement (e.g., a user approaching the door 14). In response to detecting movement, the camera 130 may provide a signal to the lockset 100, thereby activating or deactivating a component of the lockset 100.

FIG. 5 illustrates a schematic representation of an embodiment of the lockset 100 mounted to the door 14. Examples of the interior assembly 108, the exterior assembly 110, and the latch assembly 112 are shown. In other embodiments, the lockset 100 may include more or fewer components than those illustrated in connection with FIG. 5. In some embodiments, the lockset 100 may include an electrical circuit that connects one or more components of the lockset 100 described herein. In examples, the electrical circuit may receive power from a battery 142 or from a different power source. In some embodiments, the lockset 100 may include a plurality of subcircuits, each of which may include one or more components of the lockset 100 described herein, and the subcircuits may, in some embodiments, allow the lockset 100 to selectively activate or deactivate only some electrical components.

The exterior assembly 110 is shown to include the keypad 120 and an exterior antenna 133 usable for communication with a remote device. In addition, the exterior assembly 110 can include one or more sensors 131, such as a camera, proximity sensor, button, or other mechanism by which conditions exterior to the door 14 can be sensed. In some embodiments, the exterior antenna 133 (or an interior antenna 134) may include a plurality of antennas that may be configured to detect a distance and direction of an object external to the lockset 100, such as a user. For example, the lockset 100 may implement angle-of-arrival or angle-of-departure techniques to determine a location of an external object relative to the lockset 100. In response to such sensed conditions (e.g., a detection of an object external to the lockset 100), notifications may be sent by the lockset 100 to a server 18 or mobile device 200, including information associated with a sensed event (e.g., time and description of the sensed event, or remote feed of sensor data obtained via the sensor).

As described above, the latch assembly 112 may include the bolt 114. To extend and retract the bolt 114, the latch assembly 112 may include a drive shaft that is operationally coupled with a motor 132 and the bolt 114. In some embodiments, the drive shaft may rotate in a first direction to extend the bolt and a second direction to retract the bolt.

As described above, the interior assembly 108 includes the processing unit 116. The interior assembly 108 can also include a motor 132, a motion sensor 135, and an interior antenna 134. As shown, the processing unit 116 includes at least one processor 136 communicatively connected to a security chip 137, a memory 138, various wireless network interfaces, and a battery 142. The network interfaces may allow the lockset 100 to communicate with other devices via local wireless communication and/or remote wireless communication. For example, the processing unit 116 may include a network interface for communicating via the IEEE 802.11 standard (Wi-Fi®), the IEEE 802.15.4 standard (Zigbee®, Z-Wave®, and Thread), the IEEE 802.15.1 standard (Bluetooth®), ultra-wide band (UWB), or another standard. In some embodiments the Bluetooth interface 140 may be configured to communicate via a Bluetooth Low Energy (BLE) protocol. In some embodiments, a network interface for communicating via other communication protocols may be present, either instead of, or in addition to, the Wi-Fi interface 139 and the BLE interface 140. For example, the electronic lockset 100 may include a network interface for communicating according to one or more of the following protocols: Thread, Matter, near-field communication (NFC), Z-Wave, ZigBee, Narrow Band IoT (NB-IoT), LoRa, 3G, LTE, 4G, 5G, UWB, or another protocol or network. The processing unit 116 is located within the interior assembly 108 and is capable of operating the lockset 100, e.g., by actuating the motor 132 to actuate the bolt 114.

In some examples, the processor 136 can process signals received from a variety of devices to determine whether the lockset 100 should be actuated. Such processing can be based on a set of preprogramed instructions (i.e., firmware) stored in the memory 138. In certain embodiments, the processing unit 116 can include a plurality of processors 144, including one or more general purpose or specific purpose instruction processors. In some examples, the processing unit 116 is configured to capture a keypad input event from a user and store the keypad input event in the memory 138. In other examples, the processor 136 receives a signal from the exterior antenna 133, the interior antenna 134, or a motion sensor 135 (e.g., a vibration sensor, gyroscope, accelerometer, motion/position sensor, or combination thereof) and can validate received signals in order to actuate the lockset 100. In still other examples, the processor 136 receives signals from one or more network interfaces to determine whether to actuate the lockset 100.

In some embodiments, the processing unit 116 includes a security chip 137 that is communicatively interconnected with one or more instances of processor 136. The security chip 137 can, for example, generate and store cryptographic information usable to generate a certificate usable to validate the lockset 100 with a remote system, such as the server 18 or mobile device (e.g., the mobile device 200). In certain embodiments, the security chip 137 includes a one-time write function in which a portion of memory of the security chip 137 can be written only once, and then locked. Such memory can be used, for example, to store cryptographic information derived from characteristics of the lockset 100, or its communication channels with server 18 or one or more mobile devices 200. Accordingly, once written, such cryptographic information can be used in a certificate generation process which ensures that, if any of the characteristics reflected in the cryptographic information are changed, the certificate that is generated by the security chip 137 would become invalid, and thereby render the lockset 100 unable to perform various functions, such as communicate with the server 18 or mobile device 200, or operate at all, in some cases.

In some embodiments, the security chip 137 may be configured to generate a pairing passcode that, when entered using the keypad 120 of the lockset 100, triggers a pairing mode of one or more of the network interfaces of the lockset 100 that enables the lockset 100 to pair with a proximate mobile device. In some embodiments, a pairing passcode may be used to pair with a proximate mobile device. In some examples, the pairing passcode is provided to the user 12 upon initial setup/activation of the lockset 100 (e.g., via an electronic lock application associated with the lockset 100 operating on the mobile device 200). In some examples, the pairing passcode is a random value. In some examples, the user 12 may be enabled to change the pairing passcode by setting their own code or by requesting a random value to be generated by the electronic lock application operating on the mobile device 200. In some examples, the length of the pairing passcode is variable. According to an aspect, for increased security, the pairing passcode may be a limited-use passcode. For example, the pairing passcode may be limited to a single use or may be active for a preset or administrative user-selected time duration. In further examples, a digit of the pairing passcode may correspond to a setting that may instruct the lockset 100 to perform one or more of: disable the pairing passcode after it has been used; keep the pairing passcode enabled after it has been used; or reset the pairing passcode to a new random value after it has been used.

The memory 138 can include any of a variety of memory devices, such as using various types of computer-readable or computer storage media. A computer storage medium or computer-readable medium may be any medium that can store a program or instructions for performing one or more operations, steps, or methods described herein. By way of example, computer storage media may include dynamic random access memory (DRAM) or variants thereof, solid state memory, read-only memory (ROM), electrically erasable programmable ROM, and other types of devices and/or articles of manufacture that store data. Computer storage media generally includes at least one or more tangible media or devices.

Computer storage media can, in some examples, include embodiments including entirely non-transitory components. In some embodiments, the processor 136 may execute programs or instructions stored by the memory 138. In some embodiments, the memory 138 may store one or more codes that may be input by a user to actuate the bolt 114. For instance, a user may input a code into the keypad 120, or the mobile device 200 may provide a code to the lockset 100 via a network interface. To validate the code, the processor 136 may compare the input code to the one or more codes stored in the memory 138. In some embodiments, the memory 138 may store data that indicates a handing of the door 14, or the memory 138 may store data that indicates that the handing for the door 14 has not yet been determined. In some embodiments, the processor 136 may use the data indicating a handing of the door 14 as part of actuating the motor 132 to control movement of the bolt 114.

As noted above, the processing unit 116 can include one or more wireless interfaces, such as Wi-Fi interface 139, a Bluetooth interface 140, and/or another interface. Other RF circuits can be included as well. In the example shown, the interfaces 139, 140 are capable of communication using at least one wireless communication protocol. In some examples, the processing unit 116 can communicate with a remote device, such as the server 18, via a first network interface (e.g., the Wi-Fi interface 139) and with a proximate device, such as the mobile device 200, via a second network interface (e.g., the interface 140). In some embodiments, the processing unit 116 is configured to communicate with the mobile device 200 via a short-range wireless interface, such as a network interface configured to communicate using a protocol for any one or more of BLE, NFC, UWB, Thread, or another protocol. When the mobile device 200 is out of range of such a network, the mobile device 200 may communicate with the server 18, which may relay communications to the lockset 100. In some embodiments, the lockset 100 may use the Wi-Fi interface 139 to communicate with the server 18. In other embodiments, the lockset 100 may communicate with a hub device or router device using a different network protocol (e.g., BLE, NFC, Thread), and the hub device or router may route communications between the server 18 and the lockset 100.

The interior assembly 108 also includes the battery 142 to power the lockset 100. In some embodiments, the lockset 100 may include a plurality of batteries, or the lockset 100 may also include other power sources. In one example, the battery 142 may be a standard single-use (disposable) battery.

The interior assembly 108 also includes the motor 132 that is capable of actuating the bolt 114. In use, the motor 132 receives an actuation command from the processing unit 116, which causes the motor 132 to actuate the bolt 114 from the locked position to the unlocked position or from the unlocked position to the locked position. In some examples, the motor 132 actuates the bolt 114 to an opposing state. In some examples, the motor 132 receives a specified lock or unlock command, where the motor 132 only actuates the bolt 114 if the bolt 114 is in the correct position. For example, if the door 14 is locked and the motor 132 receives a lock command, then no action is taken. If the door 14 is locked and the motor 132 receives an unlock command, then the motor 132 actuates the bolt 114 to unlock the door 14. In some embodiments, the processing unit 116 will actuate the motor 132 in response to wirelessly receiving user credentials and an instruction to actuate the bolt 114. In some embodiments, the operation of the motor 132 to actuate the bolt 114 may depend at least in part on the handing of the door 14. In some embodiments, a mechanism other than the motor 132 may be used to electrically actuate the bolt 114, such as magnets or solenoids.

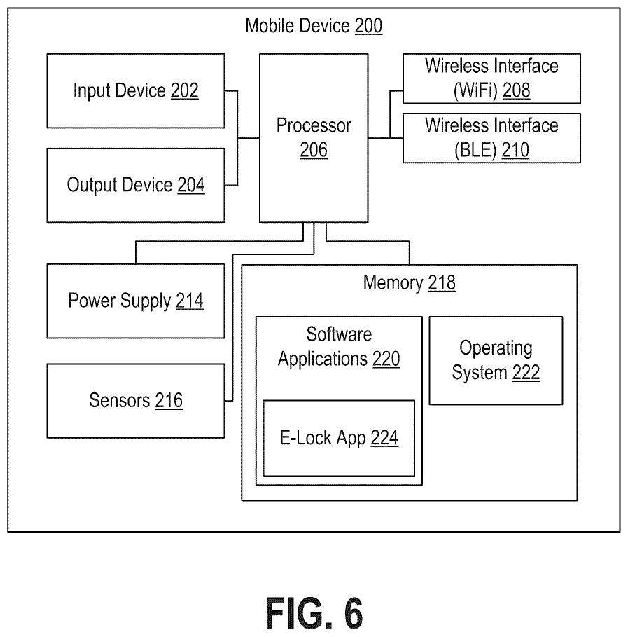

FIG. 6 illustrates a schematic diagram of a mobile device, such as the mobile device 200, usable in embodiments of the present disclosure. In some embodiments, the mobile device 200 operates to form a connection with a network-enabled security device such as the lockset 100. In some embodiments, the mobile device 200 may communicate with the server 18 via a Wi-Fi or mobile data connection. Thus, in some embodiments, the mobile device 200 can operate to communicate information between the lockset 100 and the server 18. The mobile device 200 shown in FIG. 6 includes an input device 202, an output device 204, a processor 206, a Wi-Fi interface 208, a BLE interface 210, a power supply 214, one or more sensors 216, and a memory 218. In some embodiments, the mobile device 200 may include more or fewer network interfaces. In some embodiments, the mobile device 200 may include an interface to communicate via a cellular network, a Thread protocol, a near-field communication protocol, a UWB protocol, or another protocol or network type.

The input device 202 operates to receive input from external sources. Such sources can include inputs received from a user (e.g., the user 12). The inputs can be received through a touchscreen, a stylus, or keyboard. In some embodiments, the input device may be a microphone, and the mobile device 200 may receive a voice input. In some embodiments, the input device is a camera, and the mobile device may receive an image input or a video input via the camera.

The output device 204 operates to provide output of information from the mobile device 200. For example, a display can output visual information while a speaker can output audio information.

The processor 206 reads data and instructions. The data and instructions can be stored locally, received from an external source, or accessed from removable media. In some examples, the Wi-Fi interface 208 is similar to the Wi-Fi interface 139. In some embodiments, a Wi-Fi connection may be established between the mobile deice 200 and the server 18. In some embodiments, a connection via a cellular network may be established between the mobile device 200 and the server 18. In some embodiments, the BLE interface 210 is similar to the Bluetooth interface 140. In some examples, a Bluetooth connection may be established between the mobile device 200 and the lockset 100. In some embodiments, a connection according to an NFC protocol, Thread protocol, UWB protocol, or other protocol may be established between the mobile device 200 and the lockset 100.

The power supply 214 provides power to the processor 206. The sensors 216 may include one or more sensors for collecting data associated with the mobile device 200. For example, the sensors 216 may include a GPS receiver and a motion sensor, such as an accelerometer. In alternative examples, the mobile device 200 may include additional or alternative sensors, including other environmental sensors. As described further herein, a location of the mobile device 200 may be determined using the sensors 216 (e.g., a GPS receiver). Additionally, as described further herein, motion of the mobile device 200 may be detected using the sensors 216 (e.g., an accelerometer).

The memory 218 includes software applications 220 and an operating system 222. The memory 218 contains data and instructions that are usable by the processor to implement various functions of the mobile device 200. Furthermore, the memory 218 may store credentials (e.g., a code or other alphanumeric data) that is associated with the user 12 or the mobile device 200. The mobile device 200 may provide the credentials to the lockset 100 in response to a user input or in response to receiving a communication from the lockset 100. In some embodiments, the mobile device 200 may automatically provide the credentials to the lockset 100 in response to user movement relative to a geofence, as described further herein.

The software applications 220 can include applications usable to perform various functions on the mobile device 200. One such application is an electronic lock application 224. In some embodiments, the electronic lock application 224 may be used to interact with the lockset 100. In some embodiments, the electronic lock application 224 may be used to interact with the server 18. In some embodiments, the electronic lock application 224 may be used as part of installing the lockset 100. In some embodiments, the electronic lock application 224 may be used to define a geofence associated with the lockset 100. In other embodiments, the mobile device 200 may include more or fewer components than those illustrated in the example of FIG. 6.

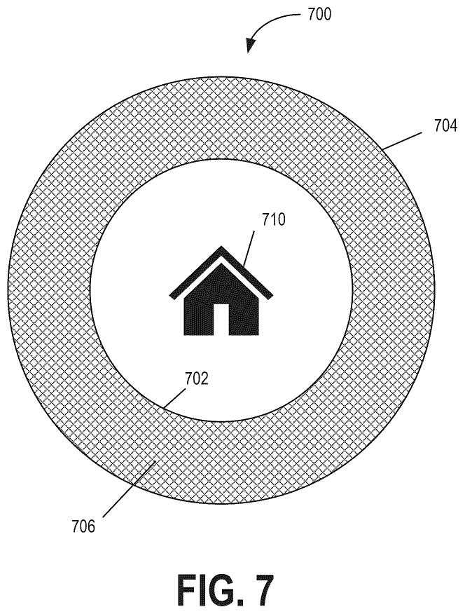

FIG. 7 illustrates an example geofence 700 associated with an electronic lockset. In embodiments, the geofence 700 may be include an entry boundary 702 and an exit boundary 704. As shown in the illustrated example, the geofence 700 may be defined around a location of interest set by a user, such as a home 710 with an electronic lockset with auto-lock and auto-unlock functionality.

In examples, an enhanced monitoring zone 706 is defined between the entry boundary 702 and the exit boundary 704. As described further herein, a location of a mobile device may be monitored (e.g., as a proxy for a location of a user) to determine when to automatically transmit lock commands and unlock commands to the electronic lockset. When the location of the mobile device is within the enhanced monitoring zone 706, the mobile device may determine its location more frequently so that the location of the user can be monitored more accurately. In an embodiment, the enhanced monitoring zone 706 is the entire area between the entry boundary 702 and the exit boundary 704. In alternative embodiments, the enhanced monitoring zone 706 may be a portion of the area between the entry boundary 702 and the exit boundary 704. In further embodiments, the enhanced monitoring zone 706 may extend beyond one or both of the entry boundary 702 and the exit boundary 704. Additionally, in some examples, the geofence 700 may include multiple enhanced monitoring zones 706, such as a first enhanced monitoring zone being associated with the auto-lock function and a second enhanced monitoring zone associated with the auto-unlock function.

Ranges and positions of the entry boundary 702 and exit boundary 704 may be defined when a user enables the auto-lock and auto-unlock functionality of the electronic lockset. In an example, the entry boundary 702 and the exit boundary 704 may be defined at a predetermined range centered on a location of interest (e.g., the home 710).

In an embodiment, the ranges of the entry boundary 702 and the exit boundary 704 may be set based on wireless communication capabilities of the electronic lockset. For example, as described above, in some embodiments, the electronic lockset may be capable of local communication with a mobile device (e.g., using a BLE wireless interface) and remote wireless communication (e.g., with a server using a Wi-Fi wireless interface). In these embodiments, the ranges of the entry boundary 702 and the exit boundary 704 may be set beyond the local wireless communication range of the electronic lockset—i.e., the ranges of the entry boundary 702 and the exit boundary 704 may be set beyond the effective range of the BLE wireless interface of the electronic lockset. In this embodiment, the electronic lockset may receive lock and unlock commands via the Wi-Fi wireless interface. For example, the mobile device may transmit lock and unlock commands to a server, and the server may transmit the commands to the electronic lockset. In an example, in this embodiment, the entry boundary 702 may be defined 30 feet from the location of interest, and the exit boundary 704 may be defined 250 feet from the location of interest.

In another embodiment, the electronic lockset may be configured only for local wireless communication (e.g., using a BLE wireless interface). In this embodiment, because the communication range at which a mobile device can communicate with the electronic lockset is limited, the ranges of the entry boundary 702 and the exit boundary 704 may be less than the corresponding ranges when the electronic lockset is additionally or alternatively configured for remote wireless communication, as described above. In an example, in this embodiment, the entry boundary 702 may have a range of 15 feet, and the exit boundary may have a range of 30 feet.

In some embodiments, the location of interest on which the entry boundary 702 and the exit boundary 704 are defined is a location at which a user enables the auto-lock and auto-unlock functionality. For example, the user may use an electronic lock application installed on a mobile device to enable the auto-lock and auto-unlock functionality. When the user enables the auto-lock and auto-unlock functionality, the mobile device may determine a position of the mobile device (e.g., using a GPS sensor) and define the entry boundary 702 and the exit boundary 704 based on the determined position of the mobile device. In other embodiments, the location of interest may be the location of the electronic lockset at which the auto-lock and auto-unlock functionality is enabled. In the illustrated example, the location of interest is the home 710.

In example embodiments, the ranges and positions of the entry boundary 702 and the exit boundary 704 may be set by the user. For example, as described further herein, the user may configure the geofence 700 using an electronic lock application executing on the user's mobile device.

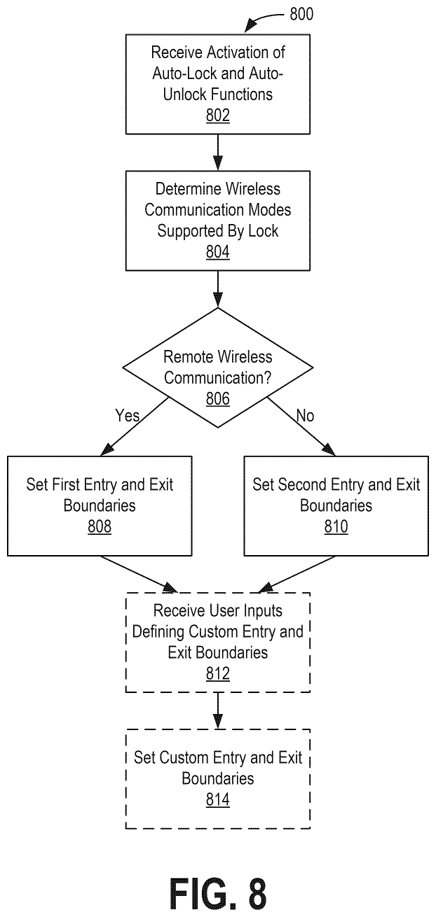

FIG. 8 illustrates a flowchart of an example method 800 for defining a geofence for auto-lock and auto-unlock functions. In the illustrated example, the method 800 includes operations 802, 804, 806, 808, 810. The method 800 may optionally also include operations 812, 814. In an example, the method 800 may be performed by a mobile device, such as the mobile device 200 described above in connection with FIG. 1.

The operation 802 includes receiving an activation of auto-lock and auto-unlock functions for an electronic lockset. In an example, a user may select an option presented in a user interface of an electronic lock application to enable the auto-lock and auto-unlock functions for the electronic lockset.

The operation 804 includes determining wireless communication capabilities of the electronic lockset—e.g., determining the wireless communication modes supported by the electronic lockset. In an example, a model of the electronic lockset may be known, and the wireless communications modes supported by the electronic lockset may be determined based on the model of the electronic lockset. In another example, the wireless communication modes supported by the electronic lockset may be determined by testing communications with the electronic lockset over a plurality of wireless communication protocols (e.g., BLE, Wi-Fi, UWB). For example, the mobile device may transmit messages over the plurality of wireless communication protocols. The mobile device may determine that wireless communication modes supported by the electronic lockset based on the wireless communication protocols over which the electronic lockset transmits a response.

The operation 806 includes determining whether the electronic lockset is capable of remote wireless communication. If the electronic lockset is capable of remote wireless communication, the method 800 may proceed to the operation 808. The operation 808 includes setting a first entry boundary and a first exit boundary for the geofence. For example, the first entry boundary may be set at a range of 30 feet centered on a current location of the mobile device, and the first exit boundary may be set at a range of 250 feet centered on the current location of the mobile device.

If the electronic lockset is not capable of remote wireless communication, the method 800 may instead proceed to the operation 810. The operation 810 includes setting a second entry boundary and a second exit boundary for the geofence. As described above, if the electronic lockset is not capable of remote wireless communication, the ranges of the entry boundary and the exit boundary may be less than if the electronic lockset is capable of remote wireless communication. In an example, the second entry boundary range may be set at a range of 15 feet centered on a current location of the mobile device, and the first exit boundary may be set at a range of 30 feet centered on the current location of the mobile device.

The method 800 may optionally include the additional operations 812, 814 through which a user may configure the geofence. The operation 812 includes receiving inputs defining a custom entry boundary and a custom exit boundary. For example, the inputs may define ranges and positions for one or both of the custom entry boundary and the custom exit boundary. As described further herein, the user inputs may be received in an electronic lock application executing on the mobile device. The operation 814 includes setting the custom entry boundary and the custom exit boundary.

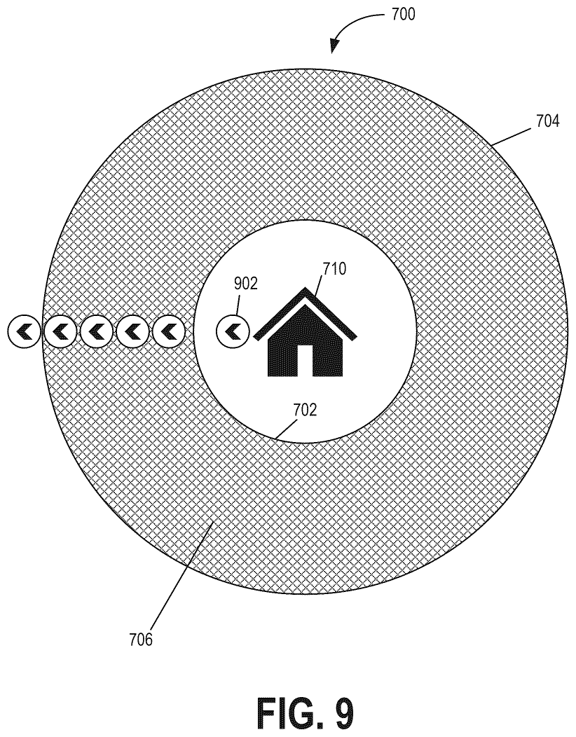

FIG. 9 illustrates an example use of an auto-lock feature of an electronic lockset using a geofence 700. As described above, the geofence 700 may include an entry boundary 702 and an exit boundary 704. An enhanced monitoring zone 706 may be defined between the entry boundary 702 and the exit boundary 704. In examples, the electronic lockset may automatically lock when a user leaves their home 710—e.g., when the user moves beyond the exit boundary 704 of the geofence 700. While the illustrated example, shows the home 710 as the location of interest around which the geofence 700 is defined, in alternative examples, the geofence 700 may be defined around other locations of interest.

Locations 902 of the user may be monitored. For example, the locations 902 by be determined based on GPS data of a mobile device carried by the user. Before an exit event is triggered, such as while the user is within the entry boundary 702 (e.g., at the home 710), the location 902 of the user may be determined a first frequency. To prevent excessive use of the mobile device that may cause a battery of the mobile device to deplete quicky, the first frequency at which the user's location 902 is determined may be low.

As the user leaves the home 710, an exit event may be triggered. In an example, the exit event is triggered when the location 902 of the user is determined to be beyond the entry boundary 702. In another example, the exit event may be triggered based on a network connection of the user's mobile device. For example, when the user's mobile device disconnects from a home Wi-Fi network, the user's mobile device may assume the user is leaving the home 710 and trigger the exit event. In an embodiment, the user's mobile device triggers the exit event.

After the exit event is triggered, the location 902 of the user may be determined at a second frequency. In an example, the second frequency may be higher than the first frequency. By determining the location 902 of the user more frequently, movement of the user may be monitored more accurately.

The location 902 of the user may be determined at the second frequency until the user moves beyond the exit boundary 704. When the user moves beyond the exit boundary 704, the user's mobile device may transmit a lock command to the electronic lockset at the home 710. In an example, the mobile device transmits the lock command directly to the electronic lockset. In another example, the mobile device transmits the lock command to a server, and the server transmits the lock command to the electronic lockset. After the lock command is transmitted from the mobile device, the location 902 of the user may be determined at the first frequency again.

In some examples, the location 902 of the user may not be determined until the exit event occurs—i.e., the first frequency may be zero. For example, if the exit event is triggered based on the user's mobile device disconnecting from a home Wi-Fi network, the location 902 of the user may not need to be monitored before the exit event is triggered. Similarly, after the user moves beyond the exit boundary 704 and the lock command is transmitted, the location 902 of the user may stop being monitored.

In examples, a server may monitor the location 902 of the user and determine when to transmit the lock command to the electronic lockset. For example, the user's mobile device may transmit location updates to the server so the server can monitor the location 902 of the user. The server may determine when the user moves beyond the exit boundary 704 and automatically transmit the lock command to the electronic lockset.

In some cases, auto-locking based on the geofence 700 may be unavailable. For example, the user's mobile device may not be able to determine the location 902 of the user—e.g., if the mobile device has a weak GPS signal or no GPS signal at all. In other examples, the auto-locking based on the geofence 700 may be unavailable because of the electronic lockset. In such cases, auto-locking may be performed using other features.

In an embodiment, the user's mobile device may determine that the user is moving and, based on the movement of the user, the mobile device may transmit a lock command to the electronic lockset. In an example, a motion sensor in the mobile device, such as an accelerometer, may be used to detect movement of the mobile device—and therefore, movement of the user. Movement of the mobile device may indicate to the mobile device that the user is leaving the home 710.

When the mobile device detects movement, the mobile device may begin to scan for the electronic lockset. For example, the mobile device may use one or more wireless interfaces to scan for the electronic lockset, which may contain one or more equivalent wireless interfaces. In some examples, the mobile device may, upon detecting the electronic lockset, transmit the lock command to the electronic lockset. In an embodiment, upon detecting the electronic lockset, the mobile device may monitor a signal strength from the electronic lockset. If the signal strength decreases, the mobile device may infer that the user is moving away from the electronic lockset and transmit the lock command to the electronic lockset. Similarly, the mobile device may compare the signal strength from the electronic lockset to a predefined signal threshold, and the mobile device may transmit the lock command to the electronic lockset when the signal strength from the electronic lockset decreases below the signal threshold.

In embodiments, the mobile device may scan for the electronic lockset over a plurality of wireless interfaces and may monitor a signal strength from the electronic lockset over the plurality of wireless interfaces. By monitoring the signal strength from the electronic lockset using multiple wireless interfaces, the mobile device may more accurately determine whether it is moving away from the electronic lockset.

In some embodiments, the user may have multiple electronic locksets at the home 710—e.g., a first electronic lockset for a front door and a second electronic lockset for a back door. In these embodiments, the mobile device may scan for multiple electronic locksets. If the mobile device detects multiple electronic locksets, the mobile device may transmit the lock command to the closest electronic lockset. In an example, the mobile device may use signal strengths from each of the electronic locksets to determine which of the electronic locksets is the closest. In other examples, other factors may be used to determine which electronic lockset is the closest. In other embodiments, the mobile device may transmit the lock command to each detected electronic lockset. In some examples, the electronic locksets that receive the lock command may decide whether to execute the lock command. For example, if the lock command is received from a user that is not authorized to control the electronic lockset, the electronic lockset may not execute the lock command.

Similarly, in some embodiments, in addition to or alternative to the mobile device scanning for electronic locksets, the electronic locksets may scan for the mobile device. If an electronic lockset detects the mobile device, the electronic lockset may determine if the mobile device is associated with a user that has enabled the geofence-based automatic lock. If the detected mobile device is associated with a user that has the automatic lock enabled, the electronic lockset may lock. In an embodiment, the mobile device may only respond to the scans from the electronic locksets after an exit event occurs. Similarly, the mobile device may only respond to the scans from the electronic locksets if the mobile device is outside the exit boundary.

In an embodiment, the geofence 700 may be used for the auto-lock feature in conjunction with detecting movement of the mobile device and scanning for the electronic lockset. In an example, when the location 902 of the user moves beyond the exit boundary 704, before transmitting the lock command, the mobile device may scan for the electronic lockset using the one or more wireless interfaces. Upon detecting the electronic lockset, the mobile device may then transmit the lock command. As described above, the mobile device may detect multiple electronic locksets. In these cases, the mobile device may transmit the lock command to one electronic lockset (e.g., the closest electronic lockset) or multiple electronic locksets. Similarly, as described above, the electronic locksets may scan for the mobile device, and the mobile device may only respond to the scans from the electronic locksets if an exit event has occurred or the mobile device is outside the exit boundary. The mobile device may additionally or alternatively use the motion sensor (e.g., accelerometer) to determine that the user is moving before transmitting the lock command when the location 902 of the user moves beyond the exit boundary 704.

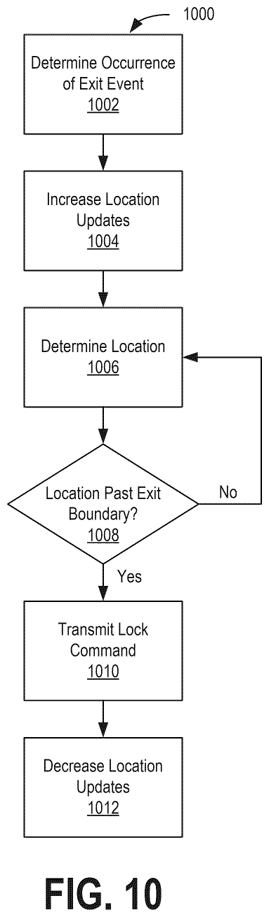

FIG. 10 illustrates a flowchart of an example method 1000 for automatically locking an electronic lockset using a geofence. In the illustrated example, the method 1000 includes operations 1002, 1004, 1006, 1008, 1010, 1012. In an example embodiment, the method 1000 is performed by a mobile device, such as the mobile device 200 described above in connection with FIG. 1.

The operation 1002 includes determining an occurrence of an exit event. In an example, the exit event occurs in response to the user moving beyond an entry boundary defined in the geofence. The location of a mobile device of the user may be used as a proxy for the location of the user. In another example, the exit event occurs in response to the mobile device of the user disconnecting from a wireless network associated with a location of interest around which the geofence is defined. For example, the exit event may occur when the user's mobile device disconnects from a home Wi-Fi network.

The operation 1004 includes increasing a frequency at which the user's location is updated. As described above, increasing the frequency at which the user's location is updated may allow movement of the user to be monitored more accurately. In an example, the user's mobile device may increase the frequency at which the mobile device determines its location using GPS data.

The operation 1006 includes determining a location of the user. In an example, the location of the user is determined based on a location of the user's mobile device. For example, GPS data may be used to determine the location of the mobile device.

The operation 1008 includes determining whether the location of the user is beyond an exit boundary defined in the geofence. If the location of the user is not beyond the exit boundary, the method 1000 may return to the operation 1006 and an updated location of the user may be determined. In an embodiment, the operations 1006, 1008 may loop, and the location of the user may be monitored until the user moves beyond the exit boundary.

If the location of the user is determined to be beyond the exit boundary, the method 1000 proceeds to the operation 1010. The operation 1010 includes transmitting a lock command to the electronic lockset. In an example, the lock command is automatically transmitted to the electronic lockset. In an embodiment, the lock command is transmitted from the user's mobile device directly to the electronic lockset via local wireless communication. In another embodiment, the lock command is transmitted to the electronic lockset via remote wireless communication. For example, the user's mobile device may transmit the lock command to a server, and the server may transmit the lock command to the electronic lockset.

In some embodiments, as described above, when the user is determined to be beyond the exit boundary, the user's mobile device may scan for the electronic lockset. In examples, the mobile device may scan for the electronic lockset using one or more communication protocols for which the electronic lockset has a corresponding wireless interface, such as Bluetooth, Wi-Fi, or UWB. If the user's mobile device detects the electronic lockset, the mobile device may then transmit the lock command to the electronic lockset. In some examples, the mobile device may detect multiple electronic locksets. In some embodiments, the mobile device may transmit the lock command to one electronic lockset (e.g., the closest electronic lockset) or multiple electronic locksets. In some embodiments, the mobile device may additionally or alternatively detect that the mobile device is moving before transmitting the lock command to the electronic lockset.

The operation 1012 includes decreasing the frequency at which the user's location is updated. By decreasing the frequency at which the user's location is updated, a battery life of the user's mobile device may be increased as the mobile device does not need to perform as many location determining operations.

While the illustrated example shows the method 1000 looping between the operations 1006, 1008 if the user's location does not move beyond the exit boundary, in some embodiments, the method 1000 may exit the loop under some circumstances. For example, if the user returns to the location around which the geofence is defined—i.e., the user returns home—the method 1000 may exit the loop. This may be determined, for example, based on the location of the user returning within the entry boundary or the user's mobile device reconnecting to the home Wi-Fi network. In another example, a timeout may occur after a predefined amount of time passes after the exit event without the user moving beyond the exit boundary, and the method 1000 may exit the loop based on the timeout. In some embodiments, when the method 1000 exits the loop of the operations 1006, 1008 under one of these circumstances, the method 1000 advances to the operation 1012 without transmitting a lock command in the operation 1010.

In alternative embodiments, one or more operations of the method 1000 may be performed by a server, such as the server 18 described above in connection with FIG. 1. For example, the server may receive location updates from the user's mobile device to monitor the location of the user. The server may then determine when the user moves beyond the exit boundary and send the lock command to the electronic lockset.

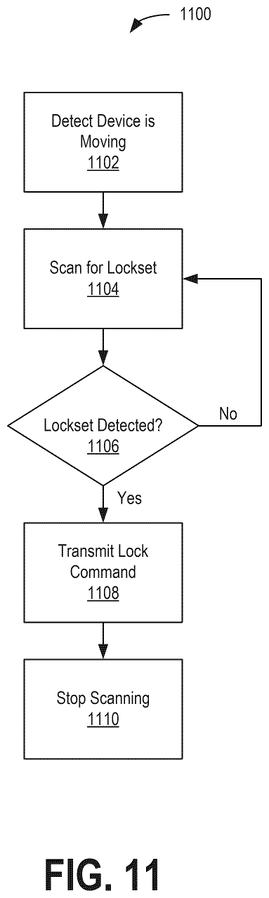

FIG. 11 illustrates a flowchart of an example method 1100 for automatically locking an electronic lockset when geofence features are unavailable. In the illustrated example, the method 1100 includes operations 1102, 1104, 1106, 1108, 1110. In an embodiment, the method 1100 may be performed by a mobile device, such as the mobile device 200 described above in connection with FIG. 1.

The operation 1102 includes detecting movement of a mobile device. In an example, the mobile device may detect movement using a motion sensor, such as an accelerometer. In other embodiments, one or more other motion sensors may additionally or alternatively be used to detect movement of the mobile device.

The operation 1104 includes scanning for an electronic lockset. In an example, one or more wireless protocols may be used to scan for the electronic lockset, including Bluetooth, Wi-Fi, or UWB. In embodiments, the mobile device may use wireless interfaces included therein to scan for the electronic lockset, which may include corresponding wireless interfaces.

The operation 1106 includes determining if the electronic lockset is detected during the scan. If the electronic lockset is not detected, the method 1100 returns to the operation 1104 and the scan for the electronic lockset continues. In an embodiment, the operations 1104, 1106 may loop, and the mobile device may scan for the electronic lockset until the electronic lockset is detected.

If the electronic lockset is detected, the method 1100 proceeds to the operation 1108. The operation 1108 includes transmitting a lock command to the electronic lockset. In an example, the lock command is automatically transmitted to the electronic lockset. In an embodiment, the lock command is transmitted from the user's mobile device directly to the electronic lockset via local wireless communication. In another embodiment, the lock command is transmitted to the electronic lockset via remote wireless communication. For example, the user's mobile device may transmit the lock command to a server, and the server may transmit the lock command to the electronic lockset.

In some embodiments, multiple electronic locksets may be detected during the scan. In an embodiment, the lock command may be transmitted to one of the detected electronic locksets. For example, the lock command may be transmitted to the closest electronic lockset. Signal strength from the electronic locksets may be used to determine which of the electronic locksets is the closest. In other embodiments, the lock command may be transmitted to multiple detected electronic locksets, such as each of detected electronic locksets.

While the illustrated example shows the method 1100 looping between the operations 1104, 1106 until the electronic lockset is detected, in some embodiments, the method 1100 may exit the loop under some circumstances. For example, if the movement of the device stops, the method 1100 may exit the loop. In another example, a timeout may occur after a predefined amount of time passes scanning for the electronic lockset, and the method 1100 may exit the loop based on the timeout. In some embodiments, when the method 1100 exits the loop of the operations 1104, 1106 under one of these circumstances, the method 1100 advances to the operation 1110 without transmitting a lock command in the operation 1108.

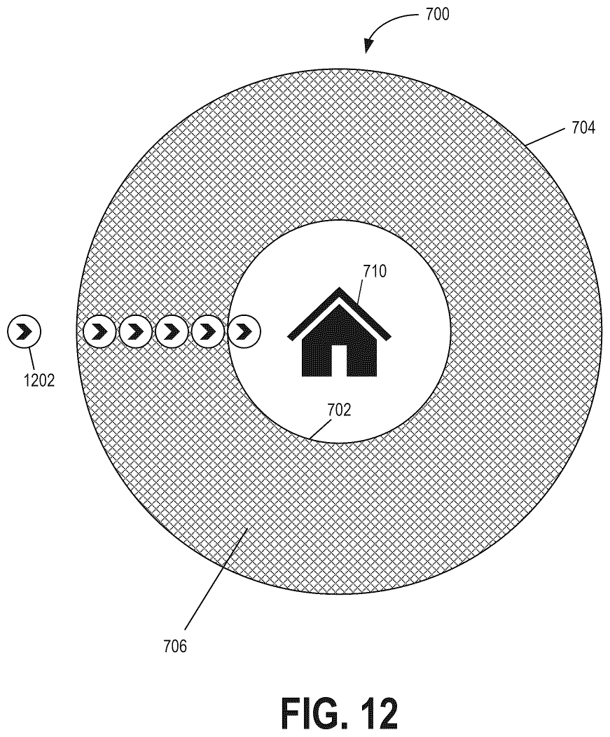

FIG. 12 illustrates an example use of an auto-unlock feature using a geofence 700. As described above, the geofence 700 may include an entry boundary 702 and an exit boundary 704. An enhanced monitoring zone 706 may be defined between the entry boundary 702 and the exit boundary 704. In examples, the electronic lockset may automatically unlock when a user returns to their home 710—e.g., when the user moves within the entry boundary 702 of the geofence 700. While the illustrated example, shows the home 710 as the location of interest around which the geofence 700 is defined, in alternative examples, the geofence 700 may be defined around other locations of interest.

Like with the auto-lock feature described above, locations 1202 of the user may be monitored, such as by monitoring GPS data of a mobile device carried by the user. Before an entry event is triggered, such as while the user is outside of the exit boundary 704, the location 1202 of the user may be determined at a first frequency. To prevent excessive use of the mobile device that may cause a battery of the mobile device to deplete quicky, the first frequency at which the user's location 1202 is determined may be low.

As the user returns to the home 710, an entry event may be triggered. In an example, the entry event is triggered when the location 1202 of the user is determined to be within the exit boundary 704. In another example, the entry event may be triggered based on a network connection of the user's mobile device. For example, when the user's mobile device connects to a home Wi-Fi network, the user's mobile device may assume the user is returning to the home 710 and trigger the entry event.

After the entry event is triggered, the location 1202 of the user may be determined at a second frequency. In an example, the second frequency may be higher than the first frequency. By determining the location 1202 of the user more frequently, movement of the user may be monitored more accurately.

The location 1202 of the user may be determined at the second frequency until the user moves within the entry boundary 702. When the user moves within the entry boundary 702, the user's mobile device may automatically transmit an unlock command to the electronic lockset at the home 710. In an example, the mobile device transmits the unlock command directly to the electronic lockset. In another example, the mobile device transmits the unlock command to a server, and the server transmits the unlock command to the electronic lockset. After the unlock command is transmitted from the mobile device, the location 1202 of the user may be determined at the first frequency again.

Like described above, in some examples, the location 1202 of the user may not be determined until the entry event occurs—i.e., the first frequency may be zero. For example, if the entry event is triggered based on the user's mobile device connecting to a home Wi-Fi network, the location 1202 of the user may not need to be monitored before the entry event is triggered. Similarly, after the user moves within the entry boundary 702 and the unlock command is transmitted, the location 1202 of the user may stop being monitored.

In other examples, a server may monitor the location 1202 of the user and determine when to transmit the unlock command to the electronic lockset. For example, the user's mobile device may transmit location updates to the server so the server can monitor the location 1202 of the user. The server may determine when the user moves within the entry boundary 702 and automatically transmit the unlock command to the electronic lockset.

In some cases, auto-unlocking based on the geofence 700 may be unavailable, similar to as described above with the auto-lock feature. In such cases, movement of the user's mobile device and wireless detection of the electronic lockset may be used to automatically unlock the electronic lockset.

Like described above, the user's mobile device may determine that the user is moving and, based on the movement of the user, the mobile device may transmit a lock command to the electronic lockset. In an example, a motion sensor in the mobile device, such as an accelerometer, may be used to detect movement of the mobile device—and therefore, movement of the user. Movement of the mobile device may indicate to the mobile device that the user is returning to the home 710.

When the mobile device detects movement, the mobile device may begin to scan for the electronic lockset. For example, the mobile device may use one or more wireless interfaces to scan for the electronic lockset, which may contain one or more equivalent wireless interfaces. In some examples, the mobile device may, upon detecting the electronic lockset, transmit the unlock command to the electronic lockset. In an embodiment, upon detecting the electronic lockset, the mobile device may monitor a signal strength from the electronic lockset. If the signal strength increases, the mobile device may infer that the user is moving towards from the electronic lockset and transmit the unlock command to the electronic lockset. Similarly, the mobile device may compare the signal strength from the electronic lockset to a predefined signal threshold, and the mobile device may transmit the unlock command to the electronic lockset when the signal strength from the electronic lockset increases above the signal threshold.

In embodiments, the mobile device may scan for the electronic lockset over a plurality of wireless interfaces and may monitor a signal strength from the electronic lockset over the plurality of wireless interfaces. By monitoring the signal strength from the electronic lockset using multiple wireless interfaces, the mobile device may more accurately determine whether it is moving towards the electronic lockset.

In some embodiments, the user may have multiple electronic locksets at the home 710—e.g., a first electronic lockset for a front door and a second electronic lockset for a back door. In these embodiments, the mobile device may scan for multiple electronic locksets. If the mobile device detects multiple electronic locksets, the mobile device may transmit the unlock command to the closest electronic lockset. In an example, the mobile device may use signal strengths from each of the electronic locksets to determine which of the electronic locksets is the closest. In other examples, other factors may be used to determine which electronic lockset is the closest.

In some embodiments when the mobile device detects multiple electronic locksets, the mobile device may transmit the unlock command to each of the detected electronic locksets. The electronic locksets may then decide whether to execute the unlock command. For example, an electronic lockset may determine that the user is not authorized to control the electronic lockset, and the electronic lockset may not execute the unlock command. In another example, an electronic lockset may use presence detection (e.g., using a motion sensor or other proximity sensor) to determine that the user is proximate the electronic lockset, and the electronic lockset may execute the unlock command based on the determination. In embodiments, a range of the presence detection may be set by a user. For example, the user may use an electronic lock application to set the range of the presence detection for the electronic lockset.

In some examples, after one of the electronic locksets executes the unlock command, the electronic lockset that executed the unlock command may inform the other electronic locksets that the unlock command has been executed. Informing other electronic locksets that the unlock command has been executed may prevent the other electronic locksets from improperly executing the unlock command, improving security at the home 710 as electronic locksets are not unnecessarily unlocked. In an example, the electronic lockset may directly communicate with the other electronic locksets when the unlock command is executed. In another example, the electronic lockset may notify a server that the unlock command has been performed, and the server may notify other electronic locksets that the unlock command has been performed. Similarly, before performing the unlock command, the electronic lockset may confirm with other electronic locksets of the server to verify that none of the other electronic locksets have already executed the unlock command.

Similarly, in some embodiments, in addition to or alternative to the mobile device scanning for electronic locksets, the electronic locksets may scan for the mobile device. If an electronic lockset detects the mobile device, the electronic lockset may determine if the mobile device is associated with a user that has enabled the geofence-based automatic unlock. If the detected mobile device is associated with a user that has the automatic unlock enabled, the electronic lockset may unlock. In an embodiment, the mobile device may only respond to the scans from the electronic locksets after an entry event occurs. Similarly, the mobile device may only respond to the scans from the electronic locksets if the mobile device is within the entry boundary. In some examples, the electronic lockset may additionally use presence detection (e.g., using a motion sensor or other proximity sensor) to determine if the user is proximate to the electronic lockset before unlocking. As described above, the electronic lockset that unlocks after detecting the mobile device may inform other electronic locksets that is has unlocked. Similarly, the electronic lockset may verify that none or the other electronic locksets have already unlocked before unlocking.

In an embodiment, the geofence 700 may be used for the auto-unlock feature in conjunction with detecting movement of the mobile device and scanning for the electronic lockset. In an example, when the location 1202 of the user moves within the entry boundary 702, before transmitting the unlock command, the mobile device may scan for the electronic lockset using the one or more wireless interfaces. Upon detecting the electronic lockset, the mobile device may then transmit the unlock command. As described above, the mobile device may detect multiple electronic locksets. In these cases, the mobile device may transmit the unlock command to one electronic lockset (e.g., the closest electronic lockset) or multiple electronic locksets. When the unlock command is transmitted to multiple electronic locksets, the electronic locksets may determine whether to execute the unlock command, as described above. Similarly, as described above, the electronic locksets may scan for the mobile device, and the mobile device may only respond to the scans from the electronic locksets if an entry event has occurred or the mobile device is within the entry boundary. The mobile device may additionally or alternatively use the motion sensor (e.g., accelerometer) to determine that the user is moving before transmitting the unlock command when the location 1202 of the user moves within the entry boundary 702.

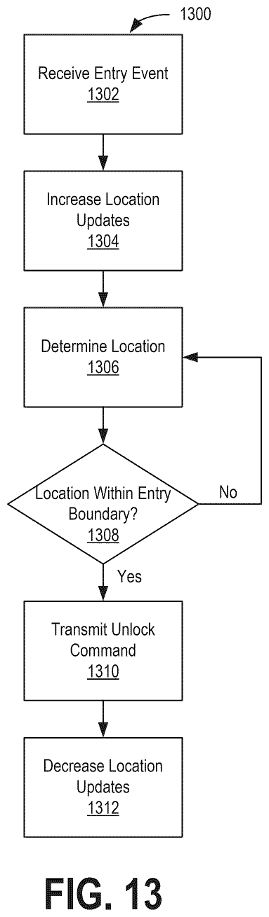

FIG. 13 illustrates a flowchart of an example method 1300 for automatically unlocking an electronic lockset using a geofence. In the illustrated example, the method 1300 includes operations 1302, 1304, 1306, 1308, 1310, 1312. In an example embodiment, the method 1300 is performed by a mobile device, such as the mobile device 200 described above in connection with FIG. 1.

The operation 1302 includes determining an occurrence of an entry event. In an example, the entry event occurs in response to the user moving within an exit boundary defined in the geofence. The location of a mobile device of the user may be used as a proxy for the location of the user. In another example, the entry event occurs in response to the mobile device of the user connecting to a wireless network associated with a location of interest around which the geofence is defined. For example, the entry event may occur when the user's mobile device connects to a home Wi-Fi network.

The operation 1304 includes increasing a frequency at which the user's location is updated. As described above, increasing the frequency at which the user's location is updated may allow movement of the user to be monitored more accurately. In an example, the user's mobile device may increase the frequency at which the mobile device determines its location using GPS data.

The operation 1306 includes determining a location of the user. In an example, the location of the user is determined based on a location of the user's mobile device. For example, GPS data may be used to determine the location of the mobile device.

The operation 1308 includes determining whether the location of the user is within an entry boundary defined in the geofence. If the location of the user is not within the entry boundary, the method 1300 may return to the operation 1306 and an updated location of the user may be determined. In an embodiment, the operations 1306, 1308 may loop, and the location of the user may be monitored until the user moves within the entry boundary.

If the location of the user is determined to be within the entry boundary, the method 1300 proceeds to the operation 1310. The operation 1310 includes transmitting an unlock command to the electronic lockset. In an example, the unlock command is automatically transmitted to the electronic lockset. In an embodiment, the unlock command is transmitted from the user's mobile device directly to the electronic lockset via local wireless communication. In another embodiment, the unlock command is transmitted to the electronic lockset via remote wireless communication. For example, the user's mobile device may transmit the unlock command to a server, and the server may transmit the unlock command to the electronic lockset.

In some embodiments, as described above, when the user is determined to be within the entry boundary, the user's mobile device may scan for the electronic lockset. In examples, the mobile device may scan for the electronic lockset using one or the communication protocols for which the electronic lockset has a corresponding wireless interface, such as Bluetooth, Wi-Fi, or UWB. If the user's mobile device detects the electronic lockset, the mobile device may then transmit the unlock command to the electronic lockset. In some examples, the mobile device may detect multiple electronic locksets. In some embodiments, the mobile device may transmit the unlock command to one electronic lockset (e.g., the closest electronic lockset) or multiple electronic locksets. In some embodiments, the mobile device may additionally or alternatively detect that the mobile device is moving before transmitting the unlock command to the electronic lockset.

The operation 1312 includes decreasing the frequency at which the user's location is updated. By decreasing the frequency at which the user's location is updated, a battery life of the user's mobile device may be increased as the mobile device does not need to perform as many location determining operations.

While the illustrated example shows the method 1300 looping between the operations 1306, 1308 if the user's location does not move within the entry boundary, in some embodiments, the method 1300 may exit the loop under some circumstances. For example, if the user moves back beyond the exit boundary or disconnects from the home Wi-Fi network, the method 1300 may exit the loop. In another example, a timeout may occur after a predefined amount of time passes after the entry event without the user moving within the entry boundary, and the method 1300 may exit the loop based on the timeout. In some embodiments, when the method 1300 exits the loop of operations 1306, 1308 under one of these circumstances, the method 1300 advances to the operation 1312 without transmitting an unlock command in the operation 1310.

In alternative embodiments, one or more operations of the method 1300 may be performed by a server, such as the server 18 described above in connection with FIG. 1. For example, the server may receive location updates from the user's mobile device to monitor the location of the user. The server may then determine when the user moves within the entry boundary and send the unlock command to the electronic lockset.

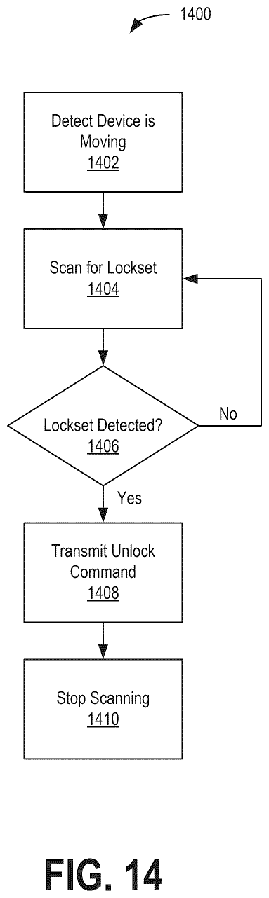

FIG. 14 illustrates a flowchart of an example method 1400 for automatically unlocking an electronic lockset when geofence features are unavailable. In the illustrated example, the method 1400 includes operations 1402, 1404, 1406, 1408, 1410. In an embodiment, the method 1400 may be performed by a mobile device, such as the mobile device 200 described above in connection with FIG. 1.

The operation 1402 includes detecting movement of a mobile device. In an example, the mobile device may detect movement using a motion sensor, such as an accelerometer. In other embodiments, one or more other motion sensors may additionally or alternatively be used to detect movement of the mobile device.

The operation 1404 includes scanning for an electronic lockset. In an example, one or more wireless protocols may be used to scan for the electronic lockset, including BLE, Wi-Fi, or UWB. In embodiments, the mobile device may use wireless interfaces included therein to scan for the electronic lockset, which may include corresponding wireless interfaces.

The operation 1406 includes determining if the electronic lockset is detected during the scan. If the electronic lockset is not detected, the method 1400 returns to the operation 1404 and the scan for the electronic lockset continues. In an embodiment, the operations 1404, 1406 may loop, and the mobile device may scan for the electronic lockset until the electronic lockset is detected.

If the electronic lockset is detected, the method 1400 proceeds to the operation 1408. The operation 1408 includes transmitting an unlock command to the electronic lockset. In an example, the unlock command is automatically transmitted to the electronic lockset. In an embodiment, the unlock command is transmitted from the user's mobile device directly to the electronic lockset via local wireless communication. In another embodiment, the unlock command is transmitted to the electronic lockset via remote wireless communication. For example, the user's mobile device may transmit the unlock command to a server, and the server may transmit the unlock command to the electronic lockset.

In some embodiments, multiple electronic locksets may be detected during the scan. In an embodiment, the unlock command may be transmitted to one of the detected electronic locksets. For example, the unlock command may be transmitted to the closest electronic lockset. Signal strength from the electronic locksets may be used to determine which of the electronic locksets is the closest. In other embodiments, the unlock command may be transmitted to multiple detected electronic locksets, such as each of detected electronic locksets.

While the illustrated example shows the method 1400 looping between the operations 1404, 1406 until the electronic lockset is detected, in some embodiments, the method 1400 may exit the loop under some circumstances. For example, if the movement of the device stops, the method 1400 may exit the loop. In another example, a timeout may occur after a predefined amount of time passes scanning for the electronic lockset, and the method 1400 may exit the loop based on the timeout. In some embodiments, when the method 1400 exits the loop of the operations 1404, 1406 under one of these circumstances, the method 1400 advances to the operation 1410 without transmitting an unlock command in the operation 1408.

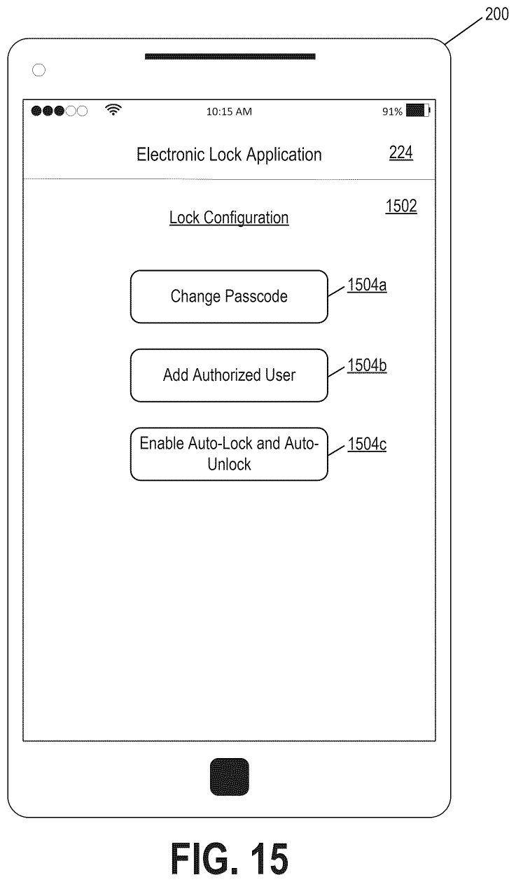

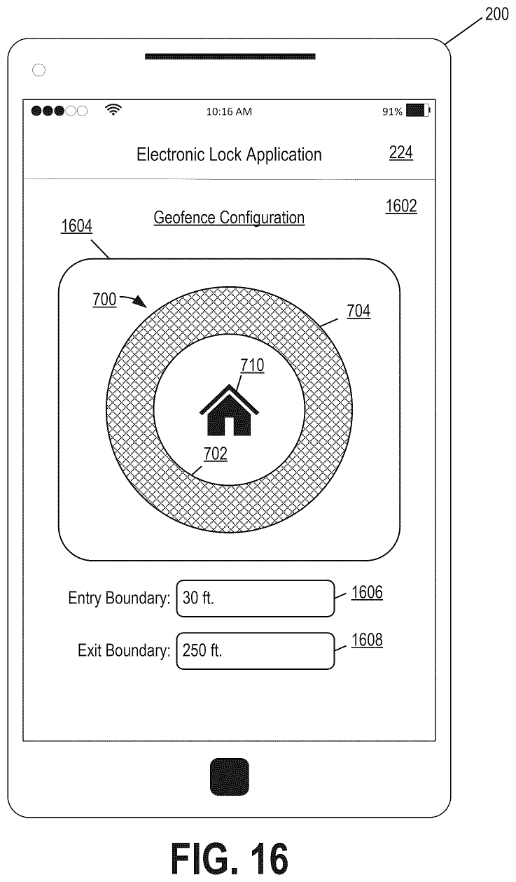

FIGS. 15-16 illustrate example user interfaces for setting a geofence for auto-lock and auto-unlock functionality for an electronic lockset. In the illustrated examples, the user interfaces are presented in an electronic lock application 224 executing on a computing device, such as a mobile device 200. In alternative examples, the user interfaces may be presented in a browser when the computing device accesses an electronic lock website.

FIG. 15 illustrates a lock configuration user interface 1502. In the illustrated example, the lock configuration user interface 1502 includes a plurality of options 1504 that a user can select to modify settings of an electronic lockset. For example, selecting a first option 1504a may allow the user to change a passcode of the electronic lockset, and selecting a second option 1504b may allow the user to add an authorized user for the electronic lockset.

A third option 1504c may allow the user to enable auto-lock and auto-unlock features for the electronic lockset. As described above, a geofence may be defined when the auto-lock and auto-unlock features are enabled. For example, the geofence may be defined around the location at which the auto-lock and auto-unlock features are enabled; an entry boundary may be defined at a first predefined range centered on the location at which the auto-lock and auto-unlock features are enabled, and an exit boundary may be defined at a second predefined range centered on the location at which the auto-lock and auto-unlock features are enabled.

FIG. 16 illustrates a geofence configuration user interface 1602. In the illustrated example, the geofence configuration user interface 1602 includes a map 1604 showing a position of a geofence 700. As described above, the geofence 700 may include an entry boundary 702 and an exit boundary 704. The map 1604 may additionally show map data near the geofence 700 such as buildings and other geographical features. In the illustrated example, the map 1604 shows the geofence 700 defined around a home 710. In alternative examples, the geofence 700 may be defined around other locations of interest.

In embodiments, the user may reconfigure the geofence 700 using the map 1604. In an example, the user may provide inputs via the map 1604 to change a position around which the geofence 700 is defined, change a range of the entry boundary 702, and change a range of the exit boundary 704. For example, the user may press and drag to resize and reposition the geofence 700.

In the illustrated example, the geofence configuration user interface 1602 also includes an entry boundary input 1606 and an exit boundary input 1608 through which the user may configure the ranges of the entry boundary 702 and the exit boundary 704, respectively. For example, the user may use the entry boundary input 1606 and the exit boundary input 1608 to input values for the ranges of the entry boundary 702 and the exit boundary 704.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A method for controlling operation of an electronic lockset, the method comprising:
defining a geofence, the geofence including an exit boundary defined at a predetermined range around an electronic lockset, wherein the predetermined range is based on wireless communication capabilities of the electronic lockset;
determining an occurrence of an exit event;
determining a location of a user;
determining whether the location of the user is located beyond the exit boundary; and
if the location of the user is located beyond the exit boundary:
transmitting a lock command to the electronic lockset.

2. The method of claim 1, further comprising:
determining an occurrence of an entry event;
determining the location of the user;
determining whether the location of the user is located within an entry boundary included in the geofence, the entry boundary defined at a second predetermined range around the electronic lockset, wherein the second predetermined range is based on the wireless communication capabilities of the electronic lockset; and
if the location of the user is located within the entry boundary:
transmitting an unlock command to the electronic lockset.

3. The method of claim 1, wherein defining the geofence includes:
determining the wireless communication capabilities of the electronic lockset; and
if the electronic lockset has remote wireless communication capabilities:
defining the range of the exit boundary at a first predetermined range; or
if the electronic lockset does not have remote wireless communication capabilities:
defining the range of the exit boundary at a second predetermined range, wherein the second predetermined range is less than the first predetermined range.

4. The method of claim 1, further comprising:
in response to determining the occurrence of the exit event, increasing a frequency at which the location of the user is determined; and
in response to determining that the location of the user is located beyond the exit boundary, decreasing the frequency at which the location of the user is determined.

5. The method of claim 1, wherein the lock command is transmitted to the electronic lockset via local wireless communication.

6. The method of claim 1, wherein the lock command is transmitted to the electronic lockset via remote wireless communication.

7. The method of claim 1, wherein determining the occurrence of the exit event includes:
determining that a mobile device of the user has disconnected from a home wireless network.

8. The method of claim 1, wherein determining the occurrence of the exit event includes:
determining that the location of the user is located beyond an entry boundary of the geofence, wherein the entry boundary is defined at a second predetermined range around the electronic lockset.

9. A system for controlling operation of an electronic lockset, the system comprising:
one or more processors; and
one or more computer-readable storage devices storing data instructions that, when executed by the one or more processors, cause the system to:
define a geofence, the geofence including an entry boundary defined at a predetermined range around an electronic lockset, wherein the predetermined range is based on wireless communication capabilities of the electronic lockset
determine an occurrence of an entry event;
determine a location of the user;
determine whether the location of the user is located within the entry boundary; and
if the location of the user is located within the entry boundary:
transmit an unlock command to the electronic lockset.

10. The system of claim 9, wherein execution of the data instructions further causes the system to:
determine an occurrence of an exit event;
determine the location of the user;
determine whether the location of the user is located beyond an exit boundary included in the geofence, the exit boundary defined at a second predetermined range around the electronic lockset, wherein the second predetermined range is based on the wireless communication capabilities of the electronic lockset; and
if the location of the user is located beyond the exit boundary:
transmit a lock command to the electronic lockset.

11. The system of claim 9, wherein to define the geofence includes to:
determine the wireless communication capabilities of the electronic lockset; and
if the electronic lockset has remote wireless communication capabilities:
define the range of the entry boundary at a first predetermined range; or
if the electronic lockset does not have remote wireless communication capabilities:
define the range of the entry boundary at a second predetermined range, wherein the second predetermined range is less than the first predetermined range.

12. The system of claim 9, wherein execution of the data instructions further causes the system to:
in response to determining the occurrence of the entry event, increasing a frequency at which the location of the user is determined; and
in response to determining that the location of the user is located within the entry boundary, decreasing the frequency at which the location of the user is determined.

13. The system of claim 9, wherein the unlock command is transmitted to the electronic lockset via local wireless communication.

14. The system of claim 9, wherein the unlock command is transmitted to the electronic lockset via remote wireless communication.

15. The system of claim 10, wherein execution of the data instructions further causes the system to:
if the location of the user is located within the entry boundary:
scan for the electronic lockset,
wherein the system transmits the unlock command to the electronic lockset in response to detecting the electronic lockset during the scan.

16. The system of claim 15, wherein execution of the data instructions further causes the system to:
if the location of the user is located within the entry boundary:
detect movement of the system,
wherein the system transmits the unlock command to the electronic lockset further in response to detecting movement of the system.

17. The system of claim 9, wherein to determine the occurrence of the entry event includes to:
determine that a mobile device of the user has connected to a home wireless network.

18. The system of claim 9, wherein to determine the occurrence of the entry event includes to:
determine that the location of the user is located within an exit boundary of the geofence, wherein the exit boundary is defined at a second predetermined range around the electronic lockset.

19. The system of claim 9, wherein to determine the location of the user includes to:
receive, from a mobile device of the user, one or more location updates including the location of the user.

20. An electronic lockset, comprising:
at least one processor;
one or more wireless communication interfaces defining wireless communication capabilities of the electronic lockset;
a bolt moveable between a locked position and an unlocked position;
a motor actuatable by the processor to move the bolt between the locked position and the unlocked position; and
a memory communicatively connected to the at least one processor, the memory storing instructions which, when executed, cause the electronic lockset to:
actuate the motor to move the bolt from the unlocked position to the locked position in response to receiving a lock command, wherein the lock command is transmitted from a mobile device in response to a location of a user moving beyond an exit boundary, the exit boundary defined at a first predetermined range around the electronic lockset; and
actuate the motor to move the bolt from the locked position to the unlocked position in response to receiving an unlock command, wherein the unlock command is transmitted from the mobile device in response to the location of the user moving within an entry boundary, the entry boundary defined at a second predetermined range around the electronic lockset,
wherein the first predetermined range and the second predetermined range are based on the wireless communication capabilities of the electronic lockset.
